(19) United States
(12) Patent Application Publication
(10) Pub. No.: US 2026/0202557 A1
(43) Pub. Date: Jul. 16, 2026

(54) X-RAY DETECTOR ASSEMBLY, X-RAY IMAGING SYSTEM AND METHOD FOR MANUFACTURING AN X-RAY DETECTOR ASSEMBLY

(71) Applicant: Carl Zeiss SMT GmbH, Oberkochen (DE)

(72) Inventor: Thomas Anthony CASE, Walnut Creek, CA (US)

(21) Appl. No.: 19/015,815

(22) Filed: Jan. 10, 2025

(51) Int. Cl. G01T 1/20; G01N 23/04; G01N 23/083; G21F 3/00

(52) U.S. Cl. CPC G01T 1/2018; G01N 23/04; G01N 23/083; G21F 3/00; G01N 2223/505; G01N 2223/6116

(57) ABSTRACT

An x-ray detector assembly for an x-ray imaging system comprises: an imaging optics arrangement with an optical axis; and a housing accommodating the imaging optics arrangement and including an x-ray entrance side. The housing has an outer shape with an inclined surface arranged, as seen in a section view through the optical axis, at an acute angle with respect to the optical axis such that the housing and/or the imaging optics arrangement or parts thereof is/are tapered towards the entrance side.

### INCORPORATION BY REFERENCE

This application incorporates by reference the following commonly owned applications filed on even date herewith:
U.S. Ser. No. ______ (Attorney Docket: 36066-0080001), entitled “X-Ray Source for an X-Ray Imaging System and X-Ray Imaging System”;
U.S. Ser. No. ______ (Attorney Docket: 36066-0081001), entitled “X-Ray Imaging System and Method for Operating an X-Ray Imaging System”;
U.S. Ser. No. ______ (Attorney Docket: 36066-0082001), entitled “Sample Mount Assembly for An X-Ray Imaging System and X-Ray Imaging System”;
U.S. Ser. No. ______ (Attorney Docket: 36066-0083001), entitled “X-Ray Source for an X-Ray Imaging System, X-Ray Imaging System and Method for Operating an X-Ray Imaging System”; and
U.S. Ser. No. ______ (Attorney Docket: 36066-0085001), entitled “X-Ray Imaging System”.

### FIELD

The present disclosure relates to an x-ray detector assembly, an x-ray imaging system with such an x-ray detector assembly, and a method for manufacturing such an x-ray detector assembly.

### BACKGROUND

X-rays are widely used in microscopy at least in part because of their short wavelengths and ability to penetrate objects. Three-dimensional (3D) x-ray imaging techniques can be useful to image internal structures of objects. Typically, based on a dataset including x-ray transmission images of a sample that are collected over a large angular range, 3D images are reconstructed. An x-ray imaging system usually comprises a sample mount to support a sample, an x-ray source configured to illuminate a region of interest of the sample, and a position-sensitive x-ray detector configured to record x-rays transmitted through the region of interest of the sample.

### SUMMARY

The present disclosure seeks to provide an improved x-ray detector assembly, an improved x-ray imaging system, and an improved method for manufacturing an x-ray detector assembly. According to a first aspect, the disclosure provides an x-ray detector assembly for an x-ray imaging system. The x-ray detector assembly comprises: an imaging optics arrangement with an optical axis; and a housing accommodating the imaging optics arrangement and including an x-ray entrance side, the housing having an outer shape with an inclined surface arranged, as seen in a section view through the optical axis, in an acute angle with respect to the optical axis such that the housing and/or the imaging optics arrangement or parts thereof is/are tapered towards the entrance side.

The x-ray detector assembly can include the housing having the inclined surface arranged in the acute angle with respect to the optical axis such that the housing is tapered towards the entrance side. This configuration can be desirable when the x-ray detector assembly is used to view the sample under an acute angle (e.g., angle from 10° to 30°). For example, when the x-ray detector assembly is arranged within an x-ray imaging system such that the sample can be viewed by the x-ray detector assembly under the acute angle, the housing of the x-ray detector assembly having the inclined surface and being tapered towards its entrance side allows, nevertheless, to arrange the x-ray detector assembly very close to the sample without contacting the sample. Thus, even when viewing the sample with the detector assembly under an acute angle, e.g., a small acute angle, a small sample-detector assembly distance can be applied without risking a collision of the detector assembly with the sample.

In some embodiments, the x-ray entrance side may comprise an x-ray transmissive entrance window. The x-ray entrance side may be configured as an opening in the housing and/or may be configured to comprise the scintillator without the x-ray transmissive entrance window.

Where appropriate in the following, the entrance window may be replaced with the x-ray entrance side, and vice versa.

For example, when using the x-ray detector assembly in an x-ray imaging system for imaging a region of interest of a sample, a distance between the sample (e.g., a surface of the sample facing the detector assembly) and the detector assembly (e.g., a surface of an entrance window of the detector assembly) is 300 millimeters (mm) or less (e.g., 100 mm or less, 50 mm or less, 10 mm or less, 5 mm or less, 3 mm or less, 1 mm or less).

By configuring a distance between the sample and the x-ray detector assembly (e.g., the entrance window of the x-ray detector assembly) very small, a compact x-ray imaging system with a small footprint can be provided.

Viewing the sample by use of the detector assembly under an acute angle, e.g., a small acute angle,—instead of an angle of 90° relative to the rotation axis—can mean that also flat extended objects such as wafers can be analyzed by 3D x-ray imaging (e.g., x-ray laminography).

Viewing the sample by use of the detector assembly under an acute angle means, for example, that the x-ray detector assembly is arranged within the x-ray imaging system such that the optical axis of the x-ray detector assembly and, hence, an x-ray propagation axis of the x-ray imaging system is inclined by the acute angle relative to an object plane of the x-ray imaging system.

The x-ray imaging system is configured for imaging a region of interest of a sample. The sample is, for example, a flat extended object. The sample is, for example, a wafer. The wafer includes, for example, electronic and/or semiconductor components. Just as an example, the x-ray imaging system may be used to inspect the wafer to investigate the quality of packaging of electronic components of the wafer. For example, the quality of mechanical and electrical bonding (e.g., buried interconnections) of the electronic components may be controlled.

However, the sample may also be another object than a wafer. The sample is, for example, a circuit board or a battery.

The x-ray imaging system is, for example, a transmission x-ray imaging system, wherein the x-rays impacting on the region of interest of the sample are partly transmitting the region of interest and are partly absorbed by the region of interest. The position-dependent transmitted portion of the x-rays is detected by the x-ray detector assembly, for example, as a two-dimensional x-ray image.

The x-ray imaging system is, for example, a three-dimensional imaging system. The x-ray imaging system is, for example, configured to obtain two-dimensional transmission images of the region of interest for different rotation angles of the sample. Based on the two-dimensional transmission images, a three-dimensional image of the region of interest can be reconstructed to reveal interior structures of the region of interest. The x-ray imaging system comprises, for example, a control device for reconstructing the three-dimensional images. The x-ray imaging system is, for example, an x-ray three-dimensional imaging system obtaining three-dimensional images by x-ray laminography and/or x-ray tomography.

The sample is, for example, supported on a rotatable sample mount for rotating the sample with respect to a rotation axis of the sample mount such that the region of interest of the sample can be imaged for different rotation angles. The sample mount has, for example, a support surface for supporting the sample. The support surface is, for example, defining an object plane of the x-ray imaging system. The optical axis of the imaging optics arrangement of the x-ray detector assembly is, for example, arranged inclined relative to the object plane.

The x-ray detector assembly is, for example, configured for position-sensitive x-ray detection of x-rays transmitted through the region of interest of the sample.

The x-ray detector assembly is, for example, configured to convert the incoming x-rays into light of longer wavelength, e.g., ultraviolet light, visible light or infrared light. The x-ray detector assembly includes, for example, a scintillator element adjacent and/or attached to the entrance window of the housing. The scintillator element is configured for converting the incoming x-rays into light of longer wavelength which is detectable by a detector of the x-ray detector assembly. The x-ray detector assembly includes, for example, the detector which is, for example, a position-sensitive detector array (e.g., a CCD or CMOS array) for detecting ultraviolet-, visible and/or infrared light.

The entrance window of the housing includes, for example, an inner surface facing an interior space of the housing. Further, the entrance window includes, for example, an outer surface which is arranged opposite the inner surface. The outer surface of the entrance window can be configured to face the sample during imaging of the sample. The inner and outer surfaces of the entrance window are, for example, arranged parallel to each other.

The entrance window is x-ray transmissive. This means, for example, that it has an x-ray transmission such that more than 50% of the x-rays irradiating the outer surface of the entrance window and having energies greater than one-half of a selected maximum focused electron energy are transmitted through the entrance window to its inner surface.

A material of the entrance window includes, for example, atomic elements having atomic numbers less than 14. The material of the entrance window includes, for example, one or more of a group including beryllium, diamond, boron carbide, silicon carbide, aluminum, and beryllium oxide.

The scintillator element is, for example, attached to the inner surface of the entrance window of the housing of the x-ray detector assembly. The scintillator element is, for example, glued, clamped or attached in another suitable manner to the inner surface of the entrance window.

Alternatively, the scintillator element may, for example, be attached (e.g., glued, clamped etc.) to the outer surface of the entrance window such that the visible photons generated by the scintillator element transmit through the entrance window.

The scintillator element may, for example, be an element using a support (such as the entrance window) or be a self-supporting element (e.g., free-standing element).

The scintillator element has, for example, a thickness in a direction parallel to the optical axis of the imaging optics arrangement of from one micrometer (μm) to 500 μm, such as from 5 μm to 50 μm.

A material of the scintillator element includes, for example, one or more of the group comprising CsI, Nal:TI, CsI:TI, CsI:Na, CsI, BaF2, CeF3, BGO, PWO:Y, LSO/LYSO, CsPbBr3 and CsPbI3.

A refractive index of the material of the scintillator element is, for example, from 1.50 to 2.20.

The x-ray detector assembly can comprise the imaging optics arrangement for imaging a transfer field in a field plane into a detection field in a detection plane via an imaging light path. The scintillator element is, for example, arranged at the transfer field. Further, the detector (detector array) is, for example, arranged in the detection field. The imaging optics arrangement comprises, for example, a pupil stop arranged in a pupil plane of the imaging optics arrangement.

The imaging optics arrangement includes, for example, an objective. The imaging optics arrangement comprises, for example, a single lens (e.g., a microscope objective lens) configured to receive at least a portion of the detectable light generated by the scintillator element and to focus a two-dimensional image on the position-sensitive detector array. The imaging optics arrangement may also comprise, for example, a plurality of lenses (e.g., an objective lens and a tube lens and/or a plurality of objective lenses). For example, the objective lens is configured to receive at least a portion of the detectable light from the scintillator element and the tube lens is configured to receive at least a portion of the detectable light from the objective lens. The tube lens is, for example, configured to focus a two-dimensional image at the detector array. A numerical aperture of the lenses of the imaging optics arrangement is, for example, in the range of from 0.1 to 0.9 (e.g., from 0.1 to 0.25, from 0.25 to 0.5, from 0.5 to 0.9). The imaging optics arrangement may, for example, be configured to project a magnified image from the scintillator element onto the detector. An optical magnification of the imaging optics arrangement may, for example, be in the range of a 4-times magnification to a 40-times magnification.

The optical axis of the imaging optics arrangement is, for example, a symmetry axis of a non-cut portion of its objective and/or a symmetry axis of a portion of the objective outside its inclined surface.

The x-ray detector assembly can comprise the housing. The housing of the x-ray detector assembly includes, for example, all (e.g., mechanical) parts of the x-ray detector assembly which form together a closed housing. The housing of the x-ray detector assembly includes, for example, multiple housing parts attached to each other. For example, the housing comprises at least the entrance window and a further housing part to which the entrance window is attached, the further housing part having an opening which is closed by the entrance window. For example, the housing comprises an optics housing part accommodating the imaging optics arrangement and a detector housing part accommodating the detector (detector array), wherein the entrance window is attached to the optics housing part and the optics housing part is attached to the detector housing part.

The housing has the inclined surface, and the inclined surface is inclined at least as seen in the section view through the optical axis. The inclined surface of the outer shape of the housing means that the housing is tapered in a direction parallel to the optical axis and towards the entrance window. This means that a first cross section of the housing at the entrance window is smaller than a second cross section of the housing spaced apart from entrance window and/or than any other cross section of the housing. The cross sections refer to sections in a direction perpendicular to the optical axis. Having the inclined surface causing the tapering means that the section size from the second cross section to the first cross section is reduced continuously and/or smoothly (and not step-wise). The term “tapered” used herein is not restricted to a conical shape but includes also other continuously/smoothly reduced cross sections.

According to some embodiments: the acute angle is 45° or less (e.g., 30° or less, 20° or less, 10° or less); the acute angle is 5° or more (e.g., 10° or more); and/or the acute angle is from 5° to 40° (e.g., from 10° to 30°).

According to some embodiments, the inclined surface is a flat surface.

That means also that the entire inclined surface is arranged in the acute angle with respect to the optical axis.

The x-ray detector assembly with the housing with the flat inclined surface is, for example, manufactured by cutting a blank x-ray detector assembly along a cutting plane arranged in the acute angle with respect to the optical axis.

According to some embodiments, the housing is shaped in a region of the inclined surface non-rotational-symmetric with respect to the optical axis.

Hence, the outer shape of the housing in the region of the inclined surface has for example not a conical shape (e.g., the shape of a truncated cone such as a truncated right circular cone). The outer shape of the housing in the region of the inclined surface results, for example, from cutting an blank x-ray detector assembly, for example, a cylindrical shaped portion (e.g., with a shape of a circular right cylinder) of its housing, along a cutting plane.

Thus, the tapered outer shape of the x-ray detector assembly is not realized by a conically tapered outer shape (which is rotational-symmetric with respect to the optical axis) but by a non-rotational-symmetric outer shape. Only that portion of the outer shape of the x-ray detector assembly (as seen in cross section perpendicular to the optical axis) is tapered which allows to arrange the x-ray detector assembly close to the sample, while the remaining portion of the x-ray detector assembly (as seen in cross section perpendicular to the optical axis) is not tapered and allows to provide certain elements such as the entrance window, a scintillator element, a shielding element and/or an (e.g., objective) lens in their full extension (with respect to a distance to the optical axis).

According to some embodiments, the housing comprises an optics housing part accommodating the imaging optics arrangement, the entrance window is attached to the optics housing part to close an opening of the optics housing part, and the optics housing part and the entrance window are shaped non-rotational-symmetric with respect to the optical axis.

According to some embodiments, the x-ray detector assembly comprises a scintillator element attached to an inner surface of the entrance window facing an interior space of the housing, wherein the scintillator element is shaped non-rotational-symmetric with respect to the optical axis.

According to some embodiments, the x-ray detector assembly comprises a shielding element for shielding a first portion of an incoming x-ray beam, wherein the shielding element is attached to an outer surface of the entrance window and comprises an opening for passing through of a second portion of the incoming x-ray beam, and the shielding element is shaped non-rotational-symmetric with respect to the optical axis.

The shielding element has, for example, a truncated ring shape, wherein the original ring shape (i.e. not truncated) is arranged and shaped rotational-symmetric with respect to the optical axis.

A material of the shielding element includes, for example, tungsten (W), bismuth (Bi), lead (Pb), platinum (Pt), depleted uranium (U) and/or another chemical element with a high atomic number (e.g., above 70).

According to some embodiments, the imaging optics arrangement comprises a lens arranged adjacent the entrance window, wherein the lens is shaped non-rotational-symmetric with respect to the optical axis.

The lens arranged adjacent the entrance window is, for example, an objective lens of the imaging optics arrangement. The lens arranged adjacent the entrance window is, for example, configured to receive at least a portion of the detectable light from the scintillator element of the x-ray detector assembly. Thus, the lens arranged adjacent the entrance window is, for example, arranged adjacent the scintillator element.

According to some embodiments, the inclined surface is a lateral surface of a truncated cone. In such embodiments, the outer shape of the housing can have a conical shape. The outer shape of the housing has, for example, the shape of a truncated cone such as a truncated right circular cone. The outer shape of the housing in the region of the inclined surface is, for example, rotational-symmetric with respect to the optical axis.

In comparison with a non-rotational-symmetric outer shape of the housing (e.g., with a flat inclined outer surface), the x-ray detector assembly can be used for imaging an sample in any rotation angle with respect to a rotation around the optical axis.

According to an aspect, the disclosure provides an x-ray imaging system. The x-ray imaging system is configured for imaging a sample arranged in an object plane of the system. The x-ray imaging system comprises: an x-ray source for emitting x-rays towards a region of interest of the sample; and an above-described x-ray detector assembly for detecting x-rays transmitted through the region of interest, wherein the optical axis of the imaging optics arrangement of the x-ray detector assembly is arranged in a further acute angle with respect to the object plane.

The x-ray imaging system comprises, for example, a rotatable sample mount for supporting the sample rotatably around a rotation axis of the sample mount. The sample mount has, for example, a support surface for supporting the sample. The support surface is, for example, defining the object plane of the x-ray imaging system.

The optical axis of the imaging optics arrangement of the x-ray detector assembly is, for example, arranged inclined relative to the object plane by the further acute angle. The further acute angle has, for example, the same value as the acute angle between the inclined outer surface of the housing of the x-ray detector assembly such that the inclined outer surface of the housing of the x-ray detector assembly is arranged parallel to the supporting surface of the sample mount and/or to a main extension plane of the sample. However, the further acute angle can, for example, also deviate (e.g., slightly) from the acute angle such that the inclined outer surface of the housing of the x-ray detector assembly is inclined (e.g., slightly) relative to the supporting surface of the sample mount and/or to a main extension plane of the sample.

The x-ray imaging system can comprise the x-ray source for generating x-rays. The x-ray source comprises, for example, a vacuum chamber. Further, the x-ray source comprises, for example, a pump for evacuating the vacuum chamber.

The x-ray source further comprises, for example, an electron source accommodated in the vacuum chamber. The electron source is configured for emitting an electron beam towards an x-ray target of the x-ray source. The electron source includes, for example, a cathode and an anode and the like for generating electrons and for accelerating the generated electrons.

The x-ray source comprises, for example, one or more electron optics units for directing, deflecting and/or shaping the electron beam emitted from the electron source. The electron optics include, for example, one or more magnetic lenses for focusing the electron beam and/or one or more deflection units for deflecting the electron beam.

The x-ray imaging system is, for example, configured for obtaining two-dimensional transmission images of the region of interest of the sample for different rotation angles of the sample with respect to the rotation axis, and for reconstructing a three-dimensional image of the region of interest based on the two-dimensional transmission images.

The x-ray source further comprises, for example, an x-ray target. The x-ray target can be configured for emitting x-rays when bombarded with the focused electron beam. A material of the at least one x-ray target comprises, for example, one or more of a group including tungsten, copper, and chromium. The x-rays generated by the at least one x-ray target can include characteristic lines determined by the target's composition and broad bremsstrahlung radiation.

The x-ray source includes, for example, a carrier element carrying the x-ray target (or carrying multiple of the x-ray targets which can be selected by directing the electron beam accordingly). The carrier element is, for example, x-ray transmissive. The carrier element forms, for example, a vacuum window of the vacuum chamber. Alternatively, an additional vacuum window may be provided. A material of the carrier element and/or the vacuum window includes, for example, atomic elements having atomic numbers less than 14. The material of the carrier element and/or the vacuum window includes, for example, one or more of a group including beryllium, diamond, boron carbide, silicon carbide, aluminum, and beryllium oxide. The material of the carrier element and/or the vacuum window can be diamond.

The carrier element and/or the vacuum window being x-ray transmissive means, for example, that it has an x-ray transmission such that more than 50% of the x-rays generated by the at least one x-ray target having energies greater than one-half of the selected maximum focused electron energy are transmitted through the carrier element.

The carrier element has, for example, a sufficiently high thermal conductivity to provide a thermal conduit to prevent thermal damage (e.g., melting) of the x-ray target. Further, the carrier element can, for example, also provide an electrically conductive path to dissipate electric charge from the at least one x-ray target and/or the carrier element itself.

The x-ray source is, for example, a transmission target type x-ray source. The electron beam can strike the at least one x-ray target of the x-ray source at its backside, the at least one x-ray target can emit x-rays at its front side, and the emitted x-rays can be used to irradiate the sample.

The x-ray source can generate diverging x-rays, i. e. a cone (conus) of x-rays. A portion (i.e. a sub cone) of the generated diverging x-rays can irradiate the region of interest of the sample. A center line of this sub cone of x-rays is referred herein as x-ray propagation axis. This means that the x-ray propagation axis indicates the direction of an x-ray beam which is a portion of the total generated diverging x-rays of the x-ray source.

According to some embodiments: the acute angle and the further acute angle deviate from each other by 20° or less (e.g., by 10° or less, by 5° or less, by 1° or less); and/or the acute angle is equal to the further acute angle.

The acute angle being equal to the further acute angle or deviating only slightly from the further acute angle allows to arrange the inclined outer surface of the housing of the x-ray detector assembly parallel or almost parallel to the supporting surface of the sample mount and/or to a main extension plane of the sample. Hence, a very small distance between the sample and the x-ray detector assembly can be applied during imaging of the sample.

According to some embodiments, the inclined surface of the housing is arranged parallel to the object plane.

In such embodiments, the acute angle is, for example, equal to the further acute angle.

According to an aspect, the disclosure provides a method for manufacturing an x-ray detector assembly for an x-ray imaging system. The method comprises: a) providing a blank x-ray detector assembly for detecting x-rays, the blank x-ray detector assembly comprising a blank imaging optics arrangement with an optical axis and a blank housing accommodating the blank imaging optics arrangement, wherein the blank housing includes a blank x-ray entrance side; and b) cutting off a portion of the blank x-ray detector assembly including a portion of the blank housing and of the blank entrance side along a cutting plane arranged in an acute angle with respect to the optical axis such that the cut housing and/or the imaging optics arrangement or parts thereof is/are tapered towards its entrance side.

The outer shape of the blank x-ray detector assembly is, for example, rotation-symmetric with respect to the optical axis. For example, the housing and the x-ray transmissive entrance window of the blank x-ray detector assembly is shaped rotational-symmetric with respect to the optical axis.

Further, components of the blank x-ray detector assembly (e.g., the blank imaging optics arrangement, the blank housing, the blank x-ray transmissive entrance window, a scintillator element, lenses of the blank imaging optics arrangement, a shielding element) are, for example, also configured rotation-symmetric with respect to the optical axis.

In contrast, the outer shape of the x-ray detector assembly after step b)—i.e., the cut x-ray detector assembly—is non-rotation-symmetric with respect to the optical axis. For example, the housing and the x-ray transmissive entrance window of the x-ray detector assembly after step b) is shaped non-rotational-symmetric with respect to the optical axis. In addition, also other components of the cut x-ray detector assembly (e.g., the imaging optics arrangement, one or more lenses of the imaging optics arrangement, a scintillator element, a shielding element) can be shaped after step b) non-rotational-symmetric with respect to the optical axis.

Cutting off a portion of the blank x-ray detector assembly includes, for example, milling, grinding, sawing or another suitable cutting process of the portion.

According to some embodiments, a portion of the blank x-ray detector assembly is cut off in step b), the portion including: a portion of a scintillator element of the blank x-ray detector assembly; a portion of an x-ray shielding element of the blank x-ray detector assembly; and/or a portion of a lens of the imaging optics arrangement of the blank x-ray detector assembly.

According to some embodiments, in step b) a hole is generated in the housing, the hole is closed by attaching an add-on housing part, and a main plane of extension of the add-on housing part is arranged in the acute angle with respect to the optical axis.

The add-on housing part can include the inclined surface of the housing of the manufactured x-ray detector assembly.

The embodiments and features described with reference to the first aspect of the present disclosure apply mutatis mutandis to the second and third aspects of the present disclosure and vice versa.

Further possible implementations or alternative solutions of the disclosure also encompass combinations—that are not explicitly mentioned herein—of features described above or below with regard to the embodiments. The person skilled in the art may also add individual or isolated aspects and features to the most basic form of the disclosure.

### BRIEF DESCRIPTION OF THE DRAWINGS

Further embodiments, features and aspects of the present disclosure will become apparent from the subsequent description and dependent claims, taken in conjunction with the accompanying drawings, in which:

FIG. 1 shows a schematic view of an x-ray imaging system for imaging a sample;

FIG. 2 shows a schematic view of an x-ray imaging system for imaging a sample;

FIG. 3 shows an entrance window of the x-ray imaging system of FIG. 2;

FIG. 4A shows a schematic view of an x-ray imaging system for imaging a sample;

FIG. 4B illustrates a cross section of a housing of an x-ray detector assembly of the x-ray imaging system of FIG. 4A;

FIG. 5 shows a schematic view of an x-ray imaging system for imaging a sample;

FIG. 6 shows a housing of an x-ray detector assembly of the x-ray imaging system of FIG. 1 or 2;

FIG. 7 shows a flow chart of a method for manufacturing an x-ray detector assembly of the x-ray imaging system of FIG. 4A or 5; and

FIG. 8 illustrates method steps of the method of FIG. 7.

### DETAILED DESCRIPTION

In the Figures, like reference numerals designate like or functionally equivalent elements, unless otherwise indicated.

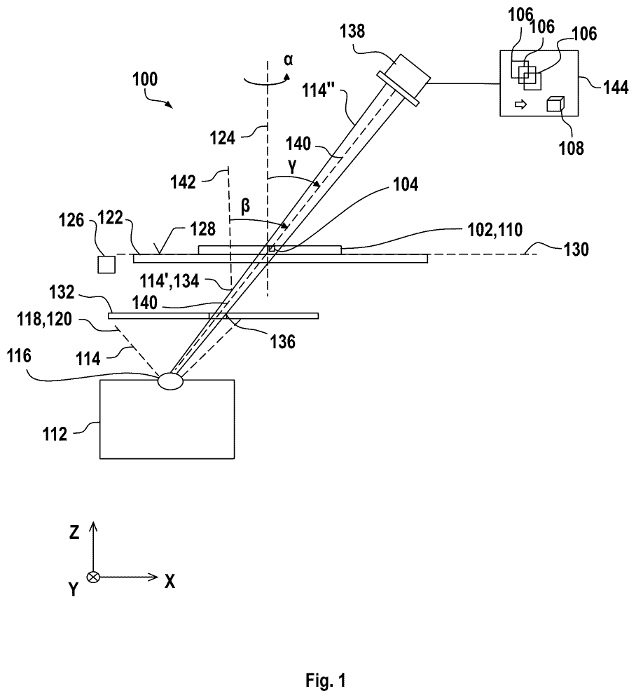

FIG. 1 shows a schematic view of an x-ray imaging system 100 to explain its basic principles. The x-ray imaging system 100 is used for imaging a sample 102, for example a region of interest 104 of the sample 102. The x-ray imaging system 100 is configured to obtain two-dimensional transmission images 106 of the region of interest 104 for different rotation angles α of the sample 102. Based on the two-dimensional transmission images 106, a three-dimensional (3D) image 108 of the region of interest 104 is reconstructed to reveal interior structures of the region of interest 104. The x-ray imaging system 100 is, hence, an x-ray 3D imaging system obtaining 3D images 108 by x-ray laminography and/or x-ray tomography.

The sample 102 is, for example, a flat object extended in a main plane (e.g., the xy-plane in FIG. 1). The sample 102 is, for example, a wafer 110 comprising electronic and/or semiconductor components. Just as an example, the x-ray imaging system 100 may be used to inspect the wafer 110 to investigate the quality of packaging of electronic components of the wafer 110. For example, the quality of mechanical and electrical bonding (e.g., buried interconnections) of the electronic components may be controlled.

The x-ray imaging system 100 comprises an x-ray source 112 for emitting x-rays 114. The x-rays 114 are emitted from a source region 116 of the x-ray source 112. The x-ray source 112 emits a diverging beam 118 of x-rays 114. In other words, the x-ray source 112 emits a cone 120 of x-rays 114. The sample 102 is arranged within the x-ray emission cone 120.

The x-ray imaging system 100 further comprises a sample mount 122 for supporting the sample 102 rotatably around a rotation axis 124. The rotation axis 124 passes, for example, through the region of interest 104 of the sample 102. For example, the rotation axis 124 can be arranged off-center with respect to a center of the sample 102. A rotation drive 126 for rotating the sample mount 122 and, hence, the sample 102, is shown schematically in FIG. 1. Furthermore, the sample mount 122 has a support surface 128 for supporting the sample 102, wherein the support surface 128 defines an object plane 130 of the x-ray imaging system 100.

The x-ray imaging system 100 may further optionally comprise, for example, a shield stop 132 arranged between the x-ray source 112 and the sample mount 122. The shield stop 132 is, for example, arranged in a light path of the x-rays 114 emitted from the x-ray source 112. The shield stop 132 serves to select a usable portion 134 (sub cone 134) of the x-ray cone 120. Moreover, the shield stop 132 protects uninspected regions of the sample 102 from x-ray exposure. The shield stop 132 has an aperture 136 through which the usable portion 134 of the x-ray light 114 (114′) propagates in the direction of the region of interest 104 of the sample 102 and transmits the region of interest 104 of the sample 102.

The x-ray imaging system 100 further comprises a position-sensitive x-ray detector assembly 138 for detecting x-rays 114″ transmitted through the region of interest 104 of the sample 102. The x-ray detector assembly 138 is, for example, configured to convert the incoming x-rays 114″ into light of longer wavelength, e.g., ultraviolet light, visible light or infrared light. The x-ray detector assembly 138 includes, for example, a scintillator material at a transfer field of the detector assembly 138 for converting the x-rays 114″ into detectable light and a detector array (e.g., a CCD or CMOS array) for detecting the detectable light.

FIG. 1 displays an x-ray propagation axis 140 of the x-ray imaging system 100. For example, a central axis of the portion 134 (sub light cone 134) of the x-ray light 114 passing through the shield stop 132 defines the x-ray propagation axis 140. The x-ray propagation axis 140 extends from the x-ray source 112 (i.e., the source region 116 of the x-ray source 112), through the region of interest 104 of the sample 102, and to the position-sensitive x-ray detector assembly 138.

As can be seen in FIG. 1, the x-ray propagation axis 140 of the x-ray imaging system 100 is, for example, inclined with respect to a surface normal 142 of the sample mount 122 by a first angle β. In addition, the x-ray propagation axis 140 is, for example, inclined with respect to the rotation axis 124 by a second angle γ. In the example of FIG. 1, the surface normal 142 of the sample mount 122 and the rotation axis 124 are arranged parallel to each other and, hence, the first angle β and the second angle γ have the same size.

The x-ray exposures 106 obtained at different rotation angles α of the sample 102 are reconstructed to a 3D image 108 by a control system 144 of the imaging system 100.

The x-ray imaging system 100 provides microscopic imaging. A magnification and, hence, a spatial resolution, of the x-ray imaging system 100 depends on the size of the source region 116 of the x-ray source 112.

Moreover, an imaging time to obtain a 3D image 108 of the region of interest 104 of the sample 102 depends on the x-ray flux density at the region of interest 104. The imaging time (exposure time) limits, for example, a throughput rate when imaging multiple samples 102 with the x-ray imaging system 100. The smaller the distance 146 between the x-ray source 112 and the sample 102, the higher is the x-ray flux density at the region of interest 104 of the sample 102. For example, the x-ray flux incident on the region of interest 104 is inversely proportional to the square of the distance 146 of the region of interest 104 from the x-ray source 112 (for example, from an x-ray target of the x-ray source 112).

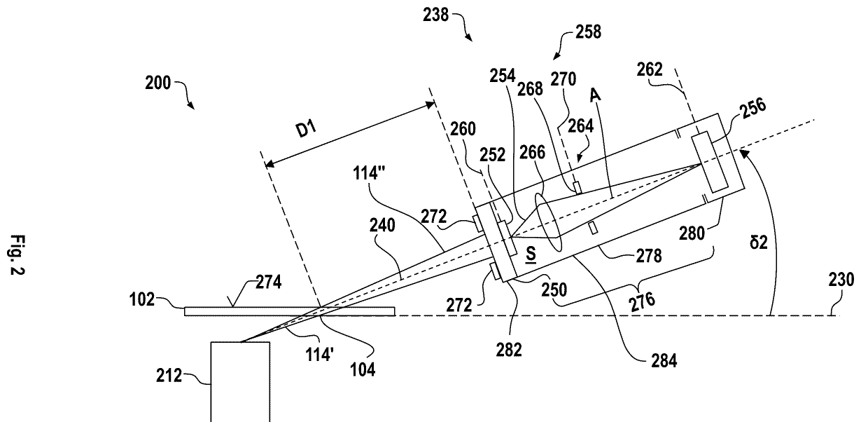

FIG. 2 shows an x-ray imaging system 200 with more details of an x-ray detector assembly 238 to explain the basic principle of an x-ray detector assembly 238.

Both FIGS. 1 and 2 show x-ray imaging systems 100, 200 according to an embodiment, while an x-ray detector assembly 138, 238 in FIGS. 1, 2 is shown not in the fully manufactured state but during a process step of manufacturing the x-ray detector assembly 138, 238.

In FIG. 2, an x-ray source 212, similar as the x-ray source 112 in FIG. 1 is shown. Further, in FIG. 2, a sample 102 is shown. A sample mount is not shown in FIG. 2 but can be configured similarly as the sample mount 122 in FIG. 1. A sample 102 is arranged in an object plane 230 similar to the object plane 130 in FIG. 1. The reference sign 240 denotes an x-ray propagation axis of the x-ray imaging system 200 similar as the x-ray propagation axis 140 in FIG. 1.

The x-ray detector assembly 238 comprises an x-ray entrance side, which can be implemented as an x-ray transmissive entrance window 250, and a scintillator element 252 for converting the incoming x-rays 114″ into detectable light 254 of longer wavelength (e.g., ultraviolet, visible or infrared light). The x-ray detector assembly 238 further comprises a position-sensitive detector 256 (e.g., detector array such as a CCD or CMOS array) for detecting the detectable light 254.

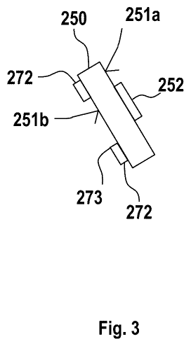

FIG. 3 shows an enlarged view of the entrance window 250, the scintillator element 252 and the shielding element 272 of FIG. 2. As can be seen in FIG. 3, the entrance window 250 includes an inner surface 251a and an outer surface 251b. Further, the scintillator element 252 is attached to the inner surface 251.

Moreover, the shielding element 272 is attached to the outer surface 251b of the entrance window 250. The shielding element 272 comprises an opening 273 for passing through of a portion of the incoming x-rays 114″.

The x-ray detector assembly 238 further comprises an imaging optics arrangement 258 for imaging a transfer field in a field plane 260 into a detection field in a detection plane 262 via an imaging light path 264. The scintillator element 252 is, for example, arranged at the transfer field in the field plane 260. Further, the detector 256 is, for example, arranged in the detection field in the detection plane 262.

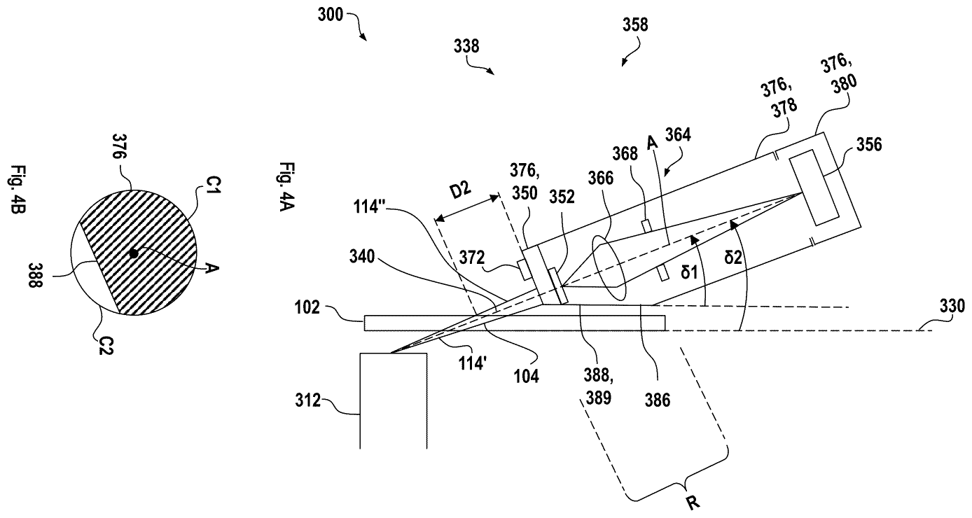

The imaging optics arrangement 258 includes one or more lenses 266 for imaging the transfer field into the detection field. FIG. 2 (and also FIGS. 4A and 5) displays only a single lens 266 for simplification reasons. However, it is to be understood that—although not shown in the figures-the imaging optics arrangement 258 may comprise several lenses 266 (e.g., a microscope/objective lens and a tubus lens), several groups of lenses and/or several sub-systems of optical components. In addition, the imaging optics arrangement 258 may include—although not shown in the figures—a zoom system which serves to vary the magnification of the imaging optics arrangement 258.

The imaging optics arrangement 138 may further comprise a pupil stop 268 arranged in a pupil plane 270 of the imaging optics arrangement 138.

The x-ray detector assembly 238 may further comprise a shielding element 268 for shielding a portion of the incoming x-rays 114″.

The x-ray detector assembly 238 comprises the housing 276. The housing 276 includes the entrance window 250, an optics housing part 278 accommodating the imaging optics arrangement 258 and a detector housing part 280 accommodating the detector 256. The entrance window 250 is attached (e.g., screwed) to the optics housing part 278, and the optics housing part 278 is attached (e.g., screwed) to the detector housing part 280.

The reference sign A in FIG. 2 denotes an optical axis of the imaging optics arrangement 138. The optical axis A of the imaging optics arrangement 138 is arranged, for example, parallel and coinciding with the x-ray propagation axis of the x-ray imaging system 200.

Furthermore, the x-ray detector assembly 238 is arranged with respect to the object plane 230 and, hence, with respect to the sample 102 such that the sample 102 is viewed under an acute angle δ2 (further acute angel), e.g., an angle δ2 between 10° to 30°).

In the example of FIG. 2, the x-ray detector assembly 238 is configured rotation-symmetric with respect to the optical axis A. For example, the shielding element 268, the entrance window 250, the scintillator element 252, the detector 256 and the imaging optics arrangement 138—for example its one or more lenses 266 and its pupil stop 268—are configured rotation-symmetric with respect to the optical axis A. Further, an outer surface 284 of the housing 276 is arranged parallel and rotation-symmetric to the optical axis A.

It can be desirable to arrange the x-ray detector assembly 238 very close to the sample 102. The reference sign DI denotes a distance between the x-ray detector assembly 238 (e.g., its entrance window 250) and the sample 102 (e.g., its upper surface 274). However, with the configuration of the x-ray detector assembly 238 shown in FIG. 2, it is difficult to arrange the x-ray detector assembly 238 very close to the sample 102 without contacting the sample 102. For example, when decreasing the distance D1 the x-ray detector assembly sample 238 would collide at its corner 282 with the sample 102.

FIG. 4A shows an x-ray imaging system 300 according to an embodiment. The x-ray imaging system 300 in FIG. 4A has a configuration which overcomes the risk of a collision of an x-ray detector assembly sample 338 with a sample 102.

The x-ray imaging system 300 in FIG. 4A comprises an x-ray source 312, similar as the x-ray source 112, 212 in FIGS. 1 and 2. Further, in FIG. 4A, a sample 102 is shown. A sample mount is not shown in FIG. 4A but can be configured similarly as the sample mount 122 in FIG. 1. The sample 102 is arranged in an object plane 330 similar to the object plane 130, 230 in FIGS. 1 and 2. The reference sign 340 denotes an x-ray propagation axis of the x-ray imaging system 300 similar as the x-ray propagation axis 140, 240 in FIGS. 1, 2.

The x-ray imaging system 300 in FIG. 4A comprises an x-ray detector assembly 338. The x-ray detector assembly 338 comprises a detector 356 similar as the detector 256 in FIG. 2.

The x-ray detector assembly 338 comprises a shielding element 372, an x-ray entrance side, optionally implemented as an x-ray transmissive entrance window 350, and a scintillator element 352 with similar functions and location in the assembly 338 as in the case of the shielding element 272, the entrance window 250 and the scintillator element 352 in FIG. 2, respectively. However, a shape of the elements 372, 350, 352 in FIG. 4A differs from FIG. 2, as explained in the following.

The x-ray detector assembly 338 in FIG. 4A further comprises an imaging optics arrangement 358 configured—similar as the imaging optics arrangement 258 in FIG. 1—for imaging a transfer field in a field plane 260 into a detection field in a detection plane 262 via an imaging light path 264 (see FIG. 2). The imaging optics arrangement 358 includes one or more lenses 366 and a pupil stop 268 similar as the imaging optics arrangement 258 in FIG. 2.

The x-ray detector assembly 338 further comprises a housing 376 accommodating the imaging optics arrangement 358, the scintillator element 352 and the detector 356. For example, the housing 376 includes the entrance window 350, an optics housing part 378 accommodating the imaging optics arrangement 358 and a detector housing part 380 accommodating the detector 356. The entrance window 350 is attached (e.g., screwed) to the optics housing part 378, and the optics housing part 378 is attached (e.g., screwed) to the detector housing part 380.

The optical axis A of the imaging optics arrangement 338 is arranged—as in FIG. 2—inclined with respect to the object plane 330 by an acute angle δ2 (further acute angle δ2) for an oblique imaging of the sample 102. Further, the optical axis A of the imaging optics arrangement 338 is arranged parallel and coinciding with the x-ray propagation axis 340 of the x-ray imaging system 300.

The housing 376 has an outer shape 386 with an inclined surface 388 arranged, at least as seen in a section view through the optical axis A, in an acute angle δ1 with respect to the optical axis A. By having the inclined surface 388, the housing 376 is tapered towards the entrance window 350.

As illustrated in FIG. 4B, the housing 376 being tapered towards the entrance window 350 means, for example, that a first cross section C1 of the housing 476 at the entrance window 350 is smaller than a second cross section C2 of the housing 476 spaced apart from entrance window 350. For example, FIG. 4B shows, in an overlay, a cross section C2 of the housing 476 outside of the region R (FIG. 4A) and a cross section C1 of the housing inside the region R. The cross sections C1, C2 refer to cross sections in a direction perpendicular to the optical axis A. It can be also seen in Fig, 4B that—in the case of a housing 476 shaped outside of the region R as a circular right cylinder—the inclined surface 388 is cutting the housing 476, as seen in the cross section perpendicular to axis A, along a chord of the circular cross section.

By tapering the housing 376 towards the entrance window 350, the x-ray detector assembly 338 can be arranged very close to the sample 102 without contacting the sample 102. Thus, with the x-ray detector assembly 338 shown in FIG. 4A, the sample 102 can be viewed under the acute angle δ1 (e.g., a small acute angle δ1 of less than 30°) and at the same time a small sample-detector assembly distance D2 can be applied without risking a collision of the detector assembly 338 with the sample 102.

The acute angle δ1 has, for example, a value smaller than 45° and/or in the range of 10° to 30° (e.g., 20°).

In the embodiment of FIG. 4A, the inclined surface 388 is a flat surface 389. That means that the inclined surface does not only appear inclined in the section view shown of FIG. 4A but is a flat plane surface 389 in the three-dimensional space.

As can be seen in FIG. 4A, the housing 376 of the x-ray detector assembly 338 is shaped in a region R of the inclined surface 388 non-rotational-symmetric with respect to the optical axis A of the detector assembly 338. This is in contrast to the housing 276 in FIG. 2.

Furthermore, in the embodiment of FIG. 4A, the optics housing part 378, the entrance window 350, the shielding element 372 and scintillator element 352 are shaped non-rotational-symmetric with respect to the optical axis A. For example, in comparison to FIG. 2, portions of the optics housing part 278, the entrance window 250, the scintillator element 252 and the scintillator element 252 of the x-ray detector assembly 238 in FIG. 2 are missing in the x-ray detector assembly 338 in FIG. 4A.

Having the x-ray detector assembly 338 (FIG. 4A), the inclined surface 388 of the housing 376 can be arranged parallel to the object plane 330. Hence, the sample 102 can be imaged with a small distance D2 to the x-ray detector assembly 338.

FIG. 5 shows an x-ray imaging system 400 with an x-ray detector assembly 438 according to a further embodiment. In the following,-apart from listing the components of the x-ray imaging system 400—mainly only differences to the x-ray imaging system 300 of FIG. 4A are described.

The x-ray imaging system 400 comprises an x-ray source 412 to image a sample 102 arranged in an object plane 430. The reference sign 340 denotes an x-ray propagation axis and 114″ denotes x-rays transmitted through a region of interest 104 of the sample 102.

The x-ray imaging system 400 comprises an x-ray detector assembly 438 with an x-ray entrance side, optionally implemented as an x-ray transmissive entrance window 450, a shielding element 472, a scintillator element 452 and a detector 456. The x-ray detector assembly 438 further comprises an imaging optics arrangement 464 with one or more lenses 466, a pupil stop 468 and optionally other components.

The x-ray detector assembly 438 comprises in addition a housing 476 including the entrance window 450, an optics housing part 478 and a detector housing part 480.

Similar as in FIGS. 2, 4A, the x-ray detector assembly 438 is arranged such that its optical axis A is arranged in an acute angle δ2 (further acute angle δ2) with respect to the object plane 430 of the system 400. Furthermore, similar as in FIGS. 2, 4A, the housing 476 of the x-ray detector assembly 438 has an outer shape 486 with an inclined surface 488. The inclined surface 488 is arranged in an acute angle δ1 with respect to the optical axis A. In the example of FIG. 5, the acute angle δ1 of the inclined surface 488 and the further acute angle δ2 between the optical axis A and the object plane 430 have the same size (δ1=δ2). Hence, in the example of FIG. 5, the inclined surface 488 is arranged parallel to the object plane 430 and, hence, to a main plane of extension of the sample 102.

In contrast to FIGS. 2, 4A, the size of the acute angle δ1 and the further acute angle δ2 is chosen smaller in FIG. 5. In FIGS. 2, 4A, the size of the acute angle δ1 and further acute angle δ2 is about 20°. In FIG. 5, the size of the acute angle δ1 and further acute angle δ2 is about 15°. That means that the sample 102 is viewed in FIG. 5 under an even smaller angle δ2 compared to FIGS. 2, 4A. In order to still ensure that the x-ray detector assembly 438 of FIG. 5 is not colliding with the sample 102, the inclined surface 488 of the housing 476 of the x-ray detector assembly 438 is also arranged in a smaller angle δ1.

Hence, in the embodiment of FIG. 5, the optics housing part 478, the entrance window 450, the shielding element 472 and scintillator element 352 are shaped non-rotational-symmetric with respect to the optical axis, similar as in FIG. 4A. Furthermore, in the embodiment of FIG. 5 (and in contrast to FIG. 4), also the imaging optics arrangement 464, for example the lens 466 (e.g., objective lens) of the imaging optics arrangement 46, is shaped non-rotational-symmetric with respect to the optical axis. For example, the lens 466 is cut at its lower portion in FIG. 5. As illustrated in FIG. 5, the portion missing of the lens 466 in FIG. 5 (missing means here missing in comparison with the lens 366 in FIG. 4A) is not essential for the imaging process. For example, the detectable light 454 (similar as the detectable light 254 in FIG. 2) is not affected by removing the portion of the lens 466.

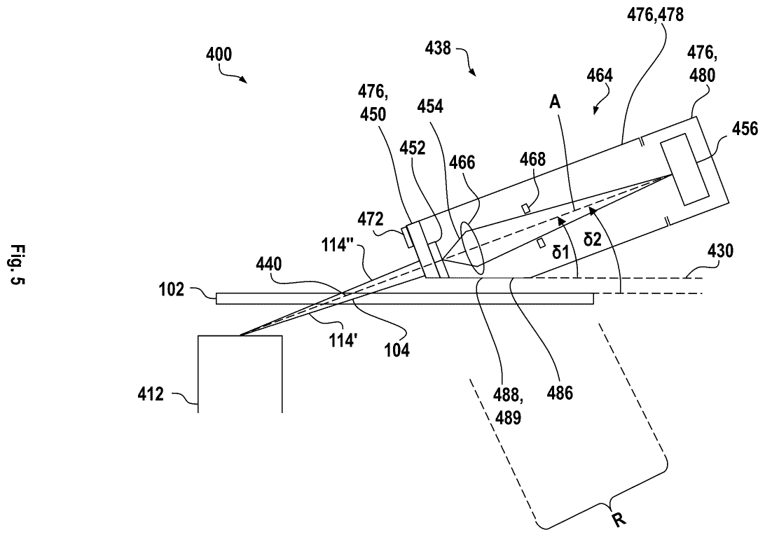

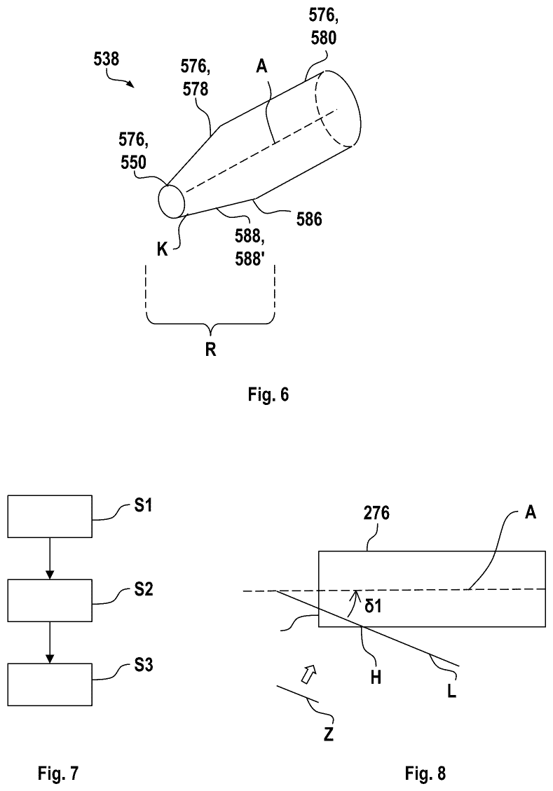

The x-ray detector assembly 300, 400 in FIGS. 4A, 5 comprises an inclined surface 388, 488 which is configured as a flat surface 389, 489. However, the inclined surface 588 may also be a lateral surface 588′ of a truncated cone K, as shown in FIG. 6.

FIG. 6 shows an x-ray detector assembly 538 of an x-ray imaging system. The x-ray detector assembly 538 can be used in the x-ray imaging systems 200, 300, 400 shown in FIGS. 2, 3, 4A instead of the respective x-ray detector assembly 238, 338, 438 shown there.

The x-ray detector assembly 538 in FIG. 6—although not shown in FIG. 6—comprises the same components as the x-ray detector assembly 338, 438 in FIGS. 4A, 5. Further, similar as in FIGS. 4A, 5, the housing 576 of the x-ray detector assembly 538 in FIG. 6 comprises an x-ray entrance side, optionally implemented as an x-ray transmissive entrance window 550, an optics housing part 578 and a detector housing part 580. Moreover, the housing 576 comprises an outer shape 586 with an inclined surface 588.

In contrast to FIGS. 4A, 5, the inclined surface 588 in FIG. 6 is not a flat surface but is instead a lateral surface 588′ of a truncated cone K. Hence, the outer shape 586 of the housing 576 in the region R of the inclined surface 588 has a conical shape, for example a shape of a truncated right circular cone K.

Thus, in the embodiment of FIG. 6, the tapered outer shape of the housing 576 of the x-ray detector assembly 538 is realized by a conically tapered outer shape which is rotational-symmetric with respect to the optical axis A. This means that—in contrast to FIGS. 4A, 5—some or all of the components of the x-ray detector assembly 538 in the region R (e.g., the shielding element 472, the entrance window 450, the scintillator element 452 and the lens 466, see FIG. 5) have to be reduced in section size (i.e. the section size perpendicular to the optical axis A).

In the following, a method for manufacturing an x-ray detector assembly 338, 438 for an x-ray imaging system 300, 400 is described with reference to FIGS. 7 and 8.

In a first step S1 of the method, an blank x-ray detector assembly 238 (FIG. 2) for detecting x-rays is provided. The blank x-ray detector assembly 238 comprises a blank imaging optics arrangement 258 with an optical axis A and a blank housing 276 accommodating the blank imaging optics arrangement 258. Furthermore, the blank housing 276 includes a blank x-ray transmissive entrance window 250.

In a second step S2 of the method, a portion P (FIG. 8) of the blank x-ray detector assembly 238 including a portion of the blank housing 276 and of the blank entrance window 250 is cut along a cutting plane L arranged in an acute angle δ1 with respect to the optical axis A such that the cut housing 376 (FIG. 4A) is tapered towards its entrance window 350.

Step S2 may include cutting a portion of a scintillator element 252 (FIG. 2) of the blank x-ray detector assembly 238, cutting a portion of an x-ray shielding element 272 of the blank x-ray detector assembly 238, and/or cutting a portion of a lens 266 of the imaging optics arrangement 258 of the blank x-ray detector assembly 238.

In step S2, a hole H (FIG. 8) may be generated in the housing 276 by the cutting process.

In a third step S3 of the method, the hole H generated in the housing 276 by the cutting process is closed by attaching an add-on housing part Z. Further, a main plane of extension of the add-on housing part Z is arranged in the acute angle δ1 (FIGS. 4A, 8) with respect to the optical axis A.

Although the present disclosure has been described in accordance with certain embodiments, it is obvious for the person skilled in the art that modifications are possible in all embodiments.

### REFERENCE NUMERALS

100 System
102 Sample
104 Region of interest
106 2D image
108 3D image
110 Wafer
112 Source
114 X-ray
114′, 114″ X-ray
116 Source region
118 Beam
120 Cone
122 Sample mount
124 Rotation axis
126 Rotation drive
128 Surface
130 Object plane
132 Shield stop
134 Sub cone
136 Aperture
138 Detector assembly
140 Axis
142 Surface normal
144 Control system
146 Distance
200 System
212 X-ray source
230 Object plane
238 Detector assembly
240 X-ray propagation axis
250 Entrance window
251a, 251b Surface
252 Scintillator element
254 Detectable light
256 Detector
258 Imaging optics arrangement
260 Field plane
262 Detection plane
264 Imaging light path
266 Lens
268 Pupil stop
270 Pupil plane
272 Shielding element
273 Opening
274 Surface
276 Housing
278 Housing part
280 Housing part
282 Corner
284 Surface
300 System
312 X-ray source
330 Object plane
338 Detector assembly
340 X-ray propagation axis
350 Entrance window
352 Scintillator element
356 Detector
358 Imaging optics arrangement
364 Imaging light path
366 Lens
368 Pupil stop
372 Shielding element
376 Housing
378 Housing part
380 Housing part
386 Shape
388 Surface
389 Surface
400 System
412 X-ray source
430 Object plane
438 Detector assembly
440 X-ray propagation axis
450 Entrance window
452 Scintillator element
456 Detector
464 Imaging optics arrangement
466 Lens
468 Pupil stop
472 Shielding element
476 Housing
478 Housing part
480 Housing part
486 Shape
488 Surface
489 Surface
538 Detector assembly
550 Entrance window
576 Housing
578 Housing part
580 Housing part
586 Shape
588 Surface
588′ Surface
α Angle
β Angle
γ Angle
δ1, δ2 Angle
A Axis
C1, C2 Cross section
D1, D2 Distance
H Hole
K Cone
L Cutting plane
P Portion
R Region
S Space
S1-S3 Method step
x, y, Z Direction
Z Housing part

What is claimed is:

1. An x-ray detector assembly, comprising:
an imaging optics arrangement with an optical axis; and
a housing accommodating the imaging optics arrangement,
wherein:
the housing comprises an x-ray entrance side;
the housing has an outer shape comprising an inclined surface disposed, as seen in a section view through the optical axis, at an acute angle with respect to the optical axis so that at least one member selected from the group consisting of the housing, the imaging optics arrangement, and parts thereof is tapered toward the entrance side of the housing.

2. The x-ray detector assembly according to claim 1, wherein at least one of the following holds:
the x-ray entrance side comprises an x-ray transmissive entrance window;
the acute angle is 45° or less;
the acute angle is 5° or more; and
the acute angle has a value of from 5° to 40°.

3. The x-ray detector assembly of claim 2, wherein:
the housing comprises an optics housing part accommodating the imaging optics arrangement;
the entrance window is attached to the optics housing part to close an opening in the optics housing part; and
the optics housing part and the entrance window are non-rotationally symmetric with respect to the optical axis.

4. The x-ray detector assembly of claim 2, further comprising a scintillator element attached to an inner surface of the entrance window facing an interior space of the housing, wherein the scintillator element is non-rotationally symmetric with respect to the optical axis.

5. The x-ray detector assembly of claim 2, further comprising a shield configured to shield a first portion of an incoming x-ray beam, wherein:
the shield is attached to an outer surface of the entrance window; and
the shield comprises an opening configured so that, during use of the x-ray detector assembly, a second portion of the incoming x-ray beam passes through the opening; and
the shield is non-rotationally symmetric with respect to the optical axis.

6. The x-ray detector assembly of claim 2, wherein the imaging optics arrangement comprises a lens adjacent the entrance window, and the lens is non-rotationally symmetric with respect to the optical axis.

7. The x-ray detector assembly of claim 2, wherein the inclined surface comprises a flat surface.

8. The x-ray detector assembly of claim 2, wherein, in a region of the inclined surface, the housing is non-rotationally symmetric with respect to the optical axis.

9. The x-ray detector assembly of claim 2, wherein the inclined surface comprises a lateral surface of a truncated cone.

10. The x-ray detector assembly of claim 1, wherein the inclined surface comprises a flat surface.

11. The x-ray detector assembly of claim 1, wherein, in a region of the inclined surface, the housing is non-rotationally symmetric with respect to the optical axis.

12. The x-ray detector assembly of claim 1, wherein the inclined surface comprises a lateral surface of a truncated cone.

13. An x-ray imaging system, comprising:
an x-ray source configured to emit x-rays toward a region of interest of a sample; and
an x-ray detector assembly according to claim 1,
wherein the x-ray detector assembly is configured to detect x-rays transmitted through the region of interest of the sample, and the optical axis of the imaging optics arrangement of the x-ray detector assembly is at a further acute angle with respect to the object plane.

14. The x-ray imaging system of claim 13, wherein the acute angle and the further acute angle deviate from each other by 20° or less, and/or the acute angle is equal to the further acute angle.

15. The x-ray imaging system of claim 13, wherein the inclined surface of the housing is parallel to the object plane.

16. The x-ray imaging system of claim 13, wherein at least one of the following holds:
the x-ray entrance side comprises an x-ray transmissive entrance window;
the acute angle is 45° or less;
the acute angle is 5° or more; and
the acute angle has a value of from 5°to 40°.

17. The x-ray imaging system of claim 16, wherein:
the housing comprises an optics housing part accommodating the imaging optics arrangement;
the entrance window is attached to the optics housing part to close an opening in the optics housing part; and
the optics housing part and the entrance window are non-rotationally symmetric with respect to the optical axis.

18. A method for manufacturing an x-ray detector assembly for an x-ray imaging system, the method comprising:
a) providing a blank x-ray detector assembly configured to detect x-rays, the blank x-ray detector assembly comprising a blank imaging optics arrangement having an optical axis and a blank housing accommodating the blank imaging optics arrangement, the blank housing comprising a blank x-ray entrance side; and
b) cutting off a portion of the blank x-ray detector assembly including a portion of the blank housing and of the blank entrance side along a cutting plane at an acute angle with respect to the optical axis so that the cut housing and/or the imaging optics arrangement or parts thereof is/are tapered towards its entrance side.

19. The method of claim 18, wherein, during b), a portion of the blank x-ray detector assembly is cut off, the portion comprising at least one of the following:
a portion of a scintillator element of the blank x-ray detector assembly;
a portion of an x-ray shield of the blank x-ray detector assembly; and
a portion of a lens of the imaging optics arrangement of the blank x-ray detector assembly.

20. The method of claim 18, wherein a hole in the housing is generated during step b), the hole is closed by attaching an add-on housing part, and a main plane of extension of the add-on housing part is at the acute angle with respect to the optical axis.
